(19) United States
(12) Patent Application Publication
(10) Pub. No.: US 2023/0368943 A1
(43) Pub. Date: Nov. 16, 2023

(54) CLIP AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Takaaki ITO, Osaka (JP)

(21) Appl. No.: 18/033,669

(22) PCT Filed: Oct. 22, 2021
(86) PCT No.: PCT/JP2021/039114

§ 371 Date: Apr. 25, 2023

(30) Foreign Application Priority Data
Nov. 9, 2020 (JP) 2020-186423

(51) Int. Cl. H01B 7/40; H01B 7/00; F16B 2/20

(52) U.S. Cl. CPC H01B 7/40; H01B 7/0045; F16B 2/20; B60R 16/0215

(57) ABSTRACT

One mode of the present disclosure provides a clip and a wire harness that make it possible to mitigate the occurrence of knocking sounds caused by vibration. The clip (9) fixes a flat electric wire bundle (6) in which electric wires (5) are lined up parallel to each other, to an attachment target. The clip (9) includes a first support portion (12), second support portions (13), and a retainer portion (14). The first support portion (12) supports the flat electric wire bundle (6) from one side. The second support portions (13) sandwich and support the flat electric wire bundle (6) together with the first support portion (12). The retainer portion (14) retains the flat electric wire bundle (6) sandwiched by the first support portion (12) and the second support portions (13).

### TECHNICAL FIELD

The present disclosure relates to a clip and a wire harness.

### BACKGROUND

It is conventional for various electrical components to be mounted in a vehicle and to electrically connect these electrical components to each other with a wire harness. In recent years, demand for securing vehicle mounting space and the like has led to studies into using, as electric wires of a wire harness, a flat electric wire bundle in which the electric wires are lined up in a plane direction (see Patent Document 1 etc.). A flat electric wire bundle is often attached to a vehicle body via clips, for example.

### PRIOR ART DOCUMENT

### Patent Document

Patent Document 1: JP 2006-262649 A

### SUMMARY OF THE INVENTION

### Problem to be Solved

Incidentally, in the case of Patent Document 1, a structure is employed where the flat electric wire bundle is attached to a vehicle body with the electric wires sandwiched between a hook-and-loop fastener and a piece of unwoven cloth, or the electric wire bundle is attached to a steel plate or the like of a vehicle body using tape. In doing so, the electric wire bundle comes into contact with the vehicle body and is constantly in contact with the vehicle body over a wide area. Thus, for example, when the vehicle body vibrates, there is a concern that the vibration will cause the electric wire bundle to come into contact with the vehicle body, which may cause a knocking or scraping sound.

It is an object of the present disclosure to provide a clip and a wire harness with which it is possible to mitigate the occurrence of knocking sounds caused by vibration.

### Means to Solve the Problem

A clip according to the present disclosure is a clip for fixing a flat electric wire bundle in which a plurality of electric wires are lined up parallel to each other to an attachment target, the clip including: a first support portion configured to support the flat electric wire bundle from one side; a second support portion configured to sandwich and support the flat electric wire bundle together with the first support portion; and a retainer portion configured to retain the flat electric wire bundle sandwiched between the first support portion and the second support portion.

A wire harness according to the present disclosure is a wire harness including a clip configured to fix a flat electric wire bundle in which a plurality of electric wires are lined up parallel to each other to an attachment target, wherein the clip includes: a first support portion configured to support the flat electric wire bundle from one side; a second support portion configured to sandwich and support the flat electric wire bundle together with the first support portion; and a retainer portion configured to retain the flat electric wire bundle sandwiched between the first support portion and the second support portion.

### Effect of the Invention

With the present disclosure, the occurrence of knocking sounds caused by vibration can be mitigated.

### BRIEF DESCRIPTION OF THE DRAWINGS

FIG. 1 is a schematic view of an attachment state of a wire harness according to an embodiment.

FIG. 2 is a perspective view showing a clip according to an embodiment.

FIG. 3 is an exploded perspective view of the clip shown in FIG. 2.

FIG. 4 is a local cross-sectional view of a portion of the clip shown in FIG. 3, showing a configuration of a locking mechanism.

FIG. 5 is a breakaway side view of an arrangement example of a first supporting portion and a second supporting portion.

FIG. 6 is a side view of the clip shown in FIG. 2.

FIG. 7 is a working diagram showing a specific example of inserting an electric wire into a holding portion.

FIG. 8 is a work diagram showing a specific example of assembling the holding portion to a fixing portion.

FIG. 9 is a perspective view of an assembled clip.

FIG. 10A is a side view showing a specific example where the wire harness shown in FIG. 1 is attached to an attachment target.

FIG. 10B is a cross-sectional view showing an enlarged portion of the wire harness shown in FIG. 10A.

FIG. 11 is a perspective view showing electric wires of an embodiment that are bent obliquely upward.

FIG. 12 is a diagram showing an action that occurs when a load is applied to a wire harness of an embodiment.

FIG. 13 is a diagram showing an action that occurs when a wire harness of an embodiment vibrates.

FIG. 14 is a breakaway side view of a clip according to a first modified example.

FIG. 15 is a plan view of a holding portion according to a second modified example.

FIG. 16 is a perspective view showing a holding portion according to a third modified example.

### DETAILED DESCRIPTION TO EXECUTE THE INVENTION

First, embodiments of the present disclosure will be listed and described.

[1] A clip according to the present disclosure is a clip for fixing a flat electric wire bundle in which a plurality of electric wires are lined up parallel to each other to an attachment target, the clip including: a first support portion configured to support the flat electric wire bundle from one side; a second support portion configured to sandwich and support the flat electric wire bundle together with the first support portion; and a retainer portion configured to retain the flat electric wire bundle sandwiched between the first support portion and the second support portion.

With the configuration of this example, inserting the electric wires between the first support portion and the second support portion results in the group of electric wires becoming the flat electric wire bundle, and the electric wires are fixed to the attachment target by fixing the clip, to which the flat electric wire bundle is attached, to the attachment target. Thus, when the flat electric wire bundle is fixed to the attachment target using the clip, the closer of the first support portion and the second support portion to the fixing portion enables the flat electric wire bundle to be disposed elevated away from the attachment target. Accordingly, the flat electric wire bundle is disposed separated from the attachment target, and thus, even if the flat electric wire bundle vibrates, a situation where the electric wire bundle comes into contact with the attachment target can be made less likely to occur. Thus, it is possible to mitigate the occurrence of knocking sounds caused by vibration.

[2] It is preferable that the first support portion is a single columnar member, and the second support portion is two columnar members. With this configuration, by performing the simple operation of inserting the electric wires between the three columnar members, the electric wires can be attached to the clip.

[3] It is preferable that an end surface of the first support portion that comes into contact with the flat electric wire bundle is disposed further in than end surfaces of the second support portions that come into contact with the flat electric wire bundle. With this configuration, the electric wires passed between the first support portion and the second support portions can be bent and pressed obliquely upward by the two second support portions. Accordingly, the electric wires between adjacent clips can have a deflected shape, and thus the electric wires can be farther separated from the attachment target. Thus, the effect of mitigating knocking sounds is further increased.

[4] It is preferable that the columnar first support portion has a larger diameter than the columnar second support portions. With this configuration, the first support portion can be made highly rigid.

[5] It is preferable that an interval in a height direction between an end surface of the first support portion that comes into contact with the flat electric wire bundle and end surfaces of the second support portions that come into contact with the flat electric wire bundle is set to match the diameter of the electric wires. With this configuration, when the electric wires are attached to the clip, only the support portions of the clip can be brought into contact with the electric wires. Thus, contact portions between the electric wires and other members can be suppressed to a low level, and thus the electric wires can be made less likely to rub against another member. Thus, the effect of mitigating knocking sounds can be further increased.

[6] It is preferable that the clip further includes a holding portion including the first support portion and the second support portions; and a fixing portion configured to support the holding portion and to be fixed to the attachment target. With this configuration, the clip can be structured such that the holding portion that has the first support portion and the second support portions can be firmly supported by the fixing portion.

[7] It is preferable that the second support portions are disposed in contact with the fixing portion or in a state where no gap is present between the second support portions and the fixing portion. With this configuration, the second support portions can be supported by the fixing portion, and thus the rigidity of the second support portions can be increased.

[8] It is preferable that the fixing portion and the holding portion are separate structures. With this configuration, the clip has a divided structure, and thus the freedom of the shapes of the holding portion and the fixing portion is increased. Thus, for example, the shape of the holding portion can be shaped so as to facilitate attachment of the electric wires. Accordingly, workability when attaching the electric wires to the attachment target using the clip can be improved.

[9] It is preferable that the clip further includes a locking mechanism configured to, when the holding portion is assembled to the fixing portion, lock an assembled state of the fixing portion and the holding portion. With this configuration, the holding portion assembled to the fixing portion can be made less likely to come loose from the fixing portion by the locking mechanism.

[10] It is preferable that the retainer portion includes a first retaining portion provided on the holding portion, and a second retaining portion provided on the fixing portion, and when the holding portion is assembled to the fixing portion, the second retaining portion is coupled to a leading end of the first support portion and leading ends of the second support portion. With this configuration, even if the entrance for inserting the electric wires is provided in the holding portion, when the holding portion is assembled to the fixing portion, this entrance can be closed by the second retaining portion of the fixing portion. Thus, the ease with which the electric wires can be attached can be increased together with suppressing dislodgment of the electric wires.

[11] A wire harness according to the present disclosure including a clip configured to fix a flat electric wire bundle in which a plurality of electric wires are lined up parallel to each other to an attachment target, wherein the clip includes: a first support portion configured to support the flat electric wire bundle from one side; a second support portion configured to sandwich and support the flat electric wire bundle together with the first support portion; and a retainer portion configured to retain the flat electric wire bundle sandwiched between the first support portion and the second support portion. With this configuration, the same operation and effects as the aforementioned clip can be obtained.

### DETAILED DESCRIPTION OF EMBODIMENTS OF DISCLOSURE

Specific examples of a clip and a wire harness of the present disclosure are described below with reference to the drawings. Note that the present invention is not limited to these examples, but is indicated by the claims, and all changes that come within the meaning and range of equivalency of the claims are intended to be embraced therein. Parts of structures may be exaggerated or simplified in the drawings for ease of description. Also, dimensional ratios of parts may differ from actual dimensional ratios.

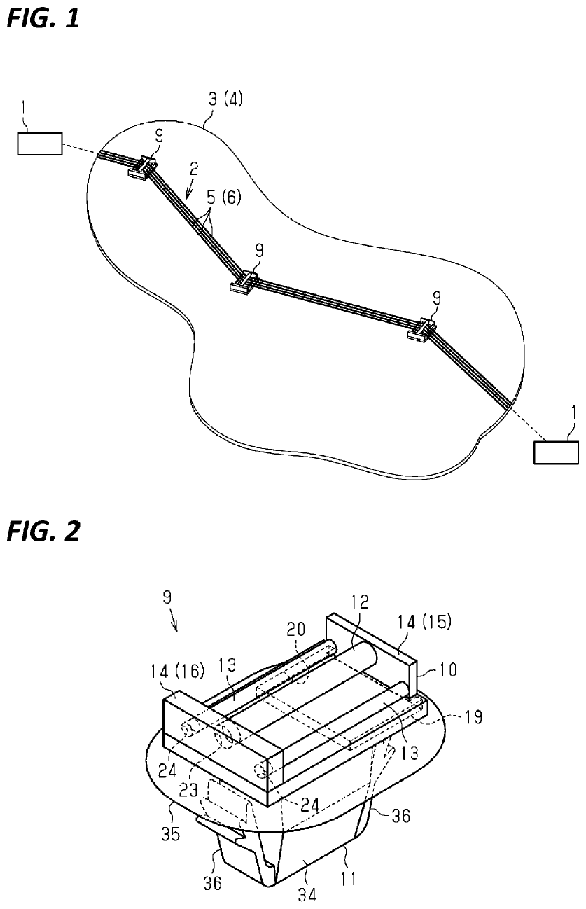

As shown in FIG. 1, a wire harness 2 that electrically connects electrical components 1 in a vehicle to a power source or an ECU (Electronic Control Unit) is attached and fixed to an attachment target 3 provided in the vehicle. The attachment target 3 is a body part 4 such as a vehicle door. The wire harness 2 includes one or more conductive electric wires 5. The electric wires 5 of this example form a flat electric wire bundle 6 in which the electric wires 5 are lined up parallel to each other. The electric wires 5 are electrically connected to the electrical components 1 via connectors (not shown) that are provided on the attachment target 3. The electrical components 1 are door lock apparatuses, various kinds of motors, speakers, or the like.

The wire harness 2 includes a plurality of clips 9 that attach and fix the electric wires 5 to the attachment target 3. In this way, the electric wires 5 of this example are attached and fixed to the attachment target 3 via the clips 9. The clips 9 of this example fix the flat electric wire bundle 6 to the attachment target 3. When more than one clip 9 is provided, the clips 9 may be disposed with equal intervals between adjacent clips 9, or alternatively disposed at uneven intervals.

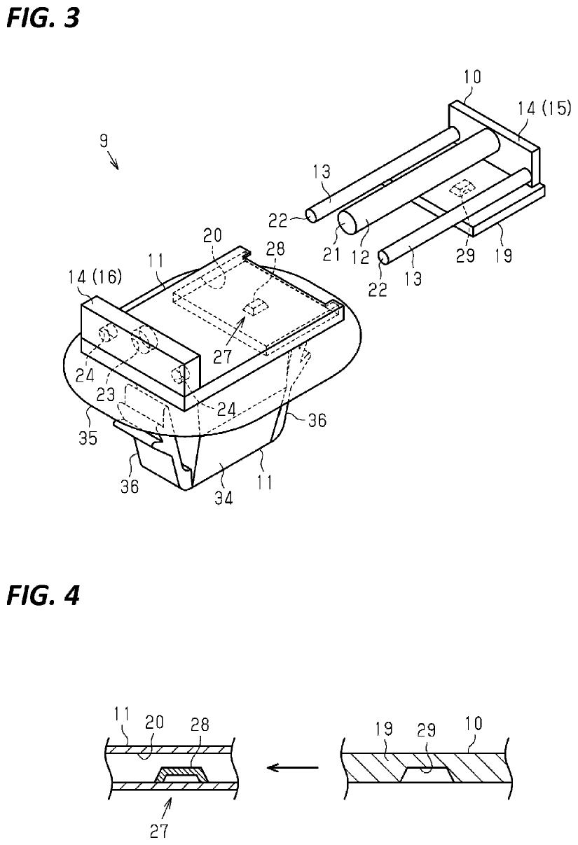

As shown in FIGS. 2 and 3, each clip 9 includes a holding portion 10 that holds the electric wires 5 (in this example, the flat electric wire bundle 6), and a fixing portion 11 that supports the holding portion 10 and is to be attached to the attachment target 3. The clip 9 is provided with a first support portion 12 that supports the flat electric wire bundle 6 from one side, second support portions 13 that sandwich and support the flat electric wire bundle 6 together with the first support portion 12, and a retainer portion 14 that retains the flat electric wire bundle 6 sandwiched between the first support portion 12 and the second support portions 13. The retainer portion 14 includes a first retaining portion 15 provided on the holding portion 10, and a second retaining portion 16 provided on the fixing portion 11.

The first support portion 12 is a single columnar member. The second support portions 13 are two columnar members. In the case of this example, the first support portion 12 and the second support portions 13 have circular elongated columnar shapes. The holding portion 10 is provided with the first support portion 12 and the second support portions 13. The first support portion 12 and the second support portions 13 are disposed so as to oppose each other.

As shown in FIG. 3, the fixing portion 11 and the holding portion 10 are separate structures. In the case of this example, the holding portion 10 has an insertion portion 19 that is to be inserted into the fixing portion 11, on an edge of the first retaining portion 15. The insertion portion 19 has a plate shape, for example. By inserting the insertion portion 19 into a groove portion 20 that is open in a side portion of the fixing portion 11, the holding portion 10 is assembled to the fixing portion 11. When the holding portion 10 is assembled to the fixing portion 11, the second retaining portion 16 is coupled to a leading end 21 of the first support portion 12 and leading ends 22 of the second support portions 13. Also, during assembly, the leading end 21 is fitted into a recessed portion 23 of the second retaining portion 16, and the leading ends 22 are respectively fitted into recessed portions 24 of the second retaining portion 16.

As shown in FIGS. 3 and 4, the clip 9 is provided with a locking mechanism 27 that locks the assembled state of the fixing portion 11 and the holding portion 10 when the fixing portion 10 is assembled to the fixing portion 11. In the case of this example, the locking mechanism 27 includes, for example, a plate spring 28 provided on an inner surface of the groove portion 20 and a recessed portion 29 that is provided on the insertion portion 19 of the holding portion 10. When the insertion portion 19 of the holding portion 10 is inserted into the groove portion 20, the plate spring 28 engages with the recessed portion 29, and thus the locking mechanism 27 enters a locked state. Thus, the holding portion 10 is fixed to the fixing portion 11.

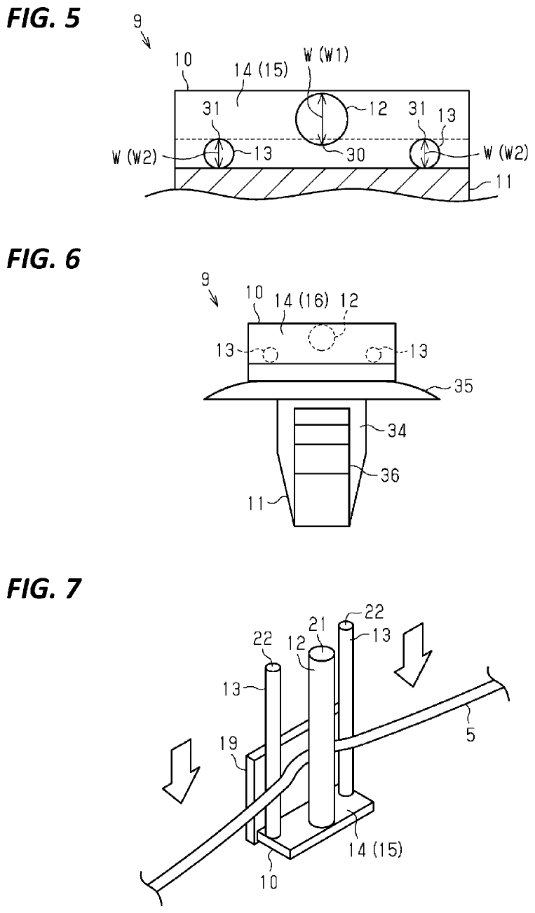

As shown in FIG. 5, the columnar first support portion 12 has a diameter W that is larger than the diameter of the columnar second support portions 13. Specifically, when the diameter W of the first support portion 12 is [W1] and the diameter W of the second support portions 13 is [W2], W1>W2 holds. The second support portions 13 are disposed in contact with the fixing portion 11 or in a state where no gap is present between the second support portions 13 and the fixing portion 11. An end surface 30 of the first support portion 12 that comes into contact with the flat electric wire bundle 6 is disposed further in (in this example, a position closer to the fixing portion 11) than end surfaces 31 of the second support portions 13 that come into contact with the flat electric wire bundle 6.

As shown in FIG. 6, the fixing portion 11 is provided with a main body portion 34, a flange portion 35 for fixing the clip 9 to the attachment target 3, and a protruding piece 36 that fixes the clip 9 to the attachment target 3 together with the flange portion 35. The main body portion 34 is disposed on the back surface of the flange portion 35, and has a substantially rectangular parallelopiped shape. The flange portion 35 is a suction cap-shaped member, for example. When, for example, two protruding pieces 36 are provided, the protruding pieces 36 are disposed at positions opposing each other across the main body portion 34. The base portions of the protruding pieces 36 are coupled to the main body portion 34, and the leading ends thereof are disposed so as to oppose the flange portion 35.

Next, operation of the clip 9 of the present embodiment will be described.

As shown in FIG. 7, an electric wire 5 is inserted into the holding portion 10. Specifically, a gap between the first support portion 12 and the second support portions 13 of the holding portion 10 acts as an entrance, and the electric wires 5 are inserted one by one to form a bundle. As a result of the electric wires 5 being stacked using the first support portion 12 and the second support portions 13, the bundle of electric wires 5 naturally becomes the flat electric wire bundle 6. In this way, in the case of this example, performing an operation of successively inserting the electric wires 5 between the first support portion 12 and the second support portions 13 makes it possible to flatten the bundle of electric wires 5.

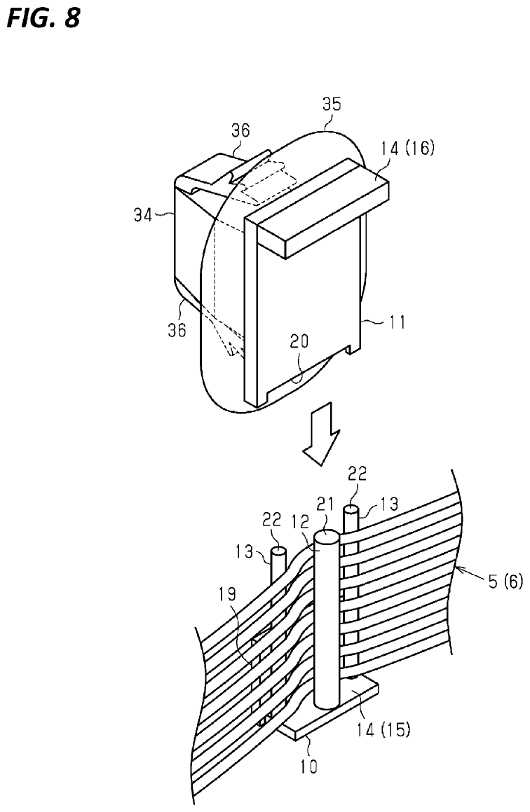

As shown in FIG. 8, once all of the electric wires 5 have been inserted into the holding portion 10, the holding portion 10 is assembled to the fixing portion 11. In the case of this example, the holding portion 10 is assembled to the fixing portion 11 by inserting the insertion portion 19 of the holding portion 10 into the groove portion 20 of the fixing portion 11 and then sliding the holding portion 10.

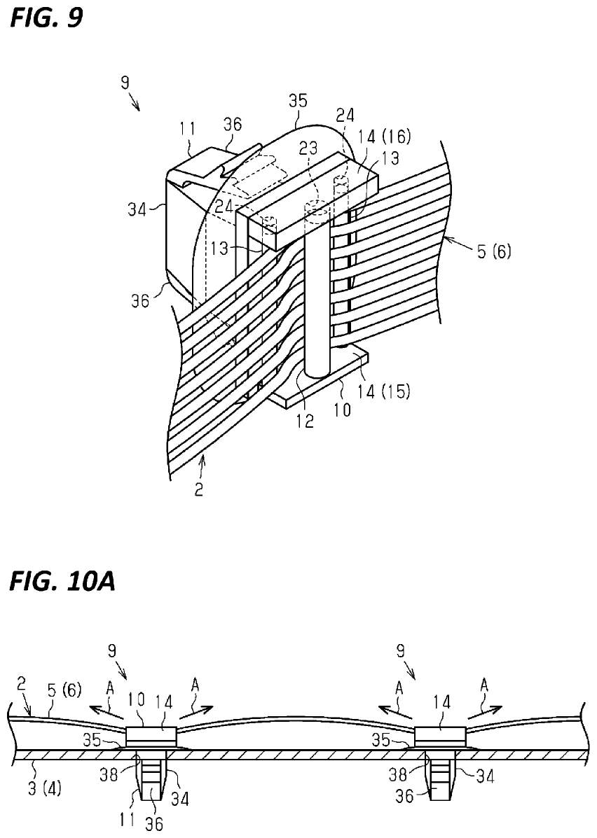

As shown in FIG. 9, once the holding portion 10 is inserted deep into the fixing portion 11, the leading end 21 of the first support portion 12 is coupled to the recessed portion 23 of the second retaining portion 16, and the leading ends 22 of the second support portions 13 are respectively coupled to the recessed portions 24 of the second retaining portion 16. Also, once the holding portion 10 has been slid the maximum amount relative to the fixing portion 11, the holding portion 10 is locked to the fixing portion 11 by the locking mechanism 27.

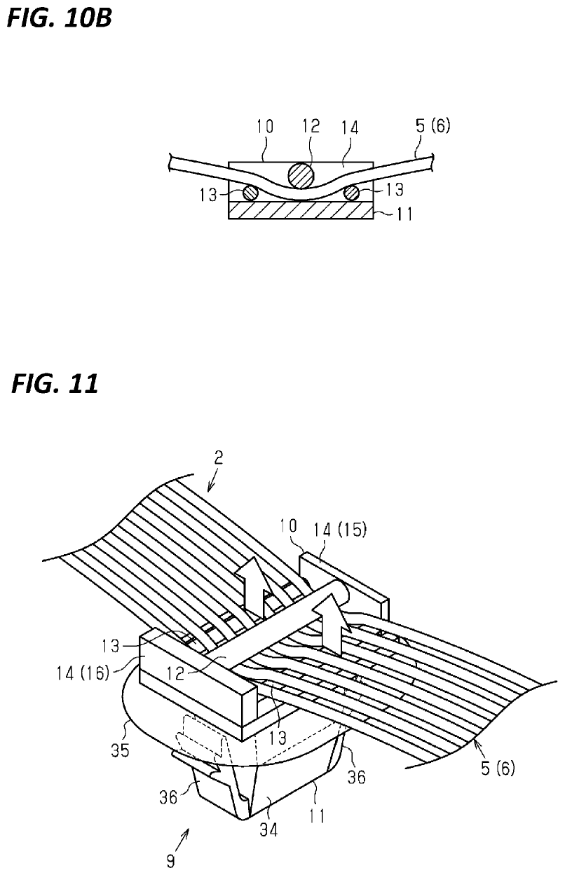

As shown in FIG. 10A, the flat electric wire bundle 6 is fixed to the attachment target 3 using clips 9. Specifically, the fixing portion 11 of each clip 9 is inserted into a hole 38 in the attachment target 3. Each hole 38 is preferably an elongated hole that matches the shape of the fixing portion 11 of the clip 9. Also, because the flange portion 35 and the protruding pieces 36 sandwich the attachment target 3, the clip 9 is firmly fixed to the attachment target 3.

In the case of this example, the wire harness 2 is attached in a state where the electric wires 5 (flat electric wire bundle 6) are separated from the attachment target 3, excluding the positions where they are fixed by the clips 9. Accordingly, the wire harness 2 is unlikely to interfere with the attachment target 3, and thus the effect of suppressing the occurrence of knocking sounds or external damage to the electric wires is increased. Also, inserting the electric wires 5 successively between the first support portion 12 and the second support portions 13 leads to the flat electric wire bundle 6 being formed. Thus, a bundle of electric wires 5 can be flattened without performing a special bundling operation, which also contributes to simplification of the operation for attaching the wire harness 2.

As shown in FIG. 10B and FIG. 11, in the case of this example, the flat electric wire bundle 6 is pressed down from above by the first support portion 12 while being lifted up from below by the two second support portions 13 (the upward direction indicated by the white arrows in FIG. 11 or the direction away from the fixing portion 11), and thus the flat electric wire bundle 6 is bent obliquely upward (the direction indicated by the A arrows in FIG. 10A). Accordingly, the flat electric wire bundle 6 is attached in a deflected shape. In the case of this example, the deflected shape is an arch shape in which the wire harness 2 sticks out away from the attachment target 3. Accordingly, when the flat electric wire cable 6 is attached to the attachment target 3, the flat electric wire bundle 6 can be brought into a state of being separated from the attachment target 3. Thus, contact between the attachment target 3 and the flat electric wire bundle 6 is suppressed to a low level, and external damage, bending, and the like is unlikely to occur.

Also, a configuration is employed where the electric wires 5 are inserted between the first support portion 12 and the second support portions 13 of the holding portion 10, and thus the simple operation of successively inserting the electric wires 5 between the first support portion 12 and the second support portions 13 makes it possible to flatten the bundle of electric wires 5. Also, the electric wires 5 are stacked in a flat shape using the holding portion 10 of the clip 9, and thus a structure can be employed where the bundle of electric wires 5 can be flattened at the positions of the clips 9, that is, the positions where the clips 9 are fixed to the attachment target 3.

Furthermore, in the case of the clip 9 in this example, the holding portion 10 has a structural feature, and thus the fixing portion 11 can also have a conventional structure. In this case, the hole 38 in the attachment target 3 can also have the same shape as a conventional shape. Also, provided that it is possible to mitigate knocking sounds caused by vibration, there is no need to provide a separate member to serve as a measure against knocking sounds, and thus the present invention is advantageous in this regard. Furthermore, such a separate member not being required contributes to further simplification of an operation to attach the wire harness 2.

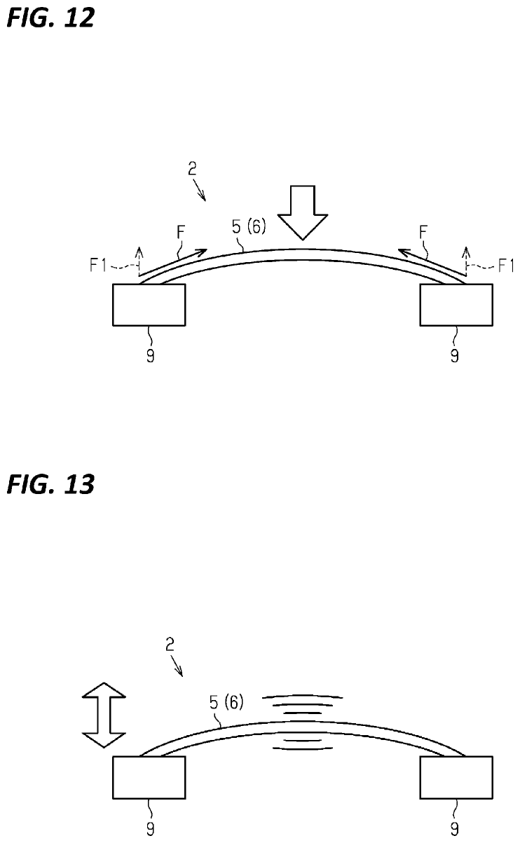

As shown in FIG. 12, an example is shown where the flat electric wire bundle 6 is subjected to a load from above. In the case of this example, the flat electric wire bundle 6 is attached and fixed to the attachment target 3 so as to have a deflected shape, and thus the flat electric wire bundle 6 is fixed to the attachment target 3 is a state where flexural rigidity is applied. That is, the flat electric wire bundle 6 is attached to the attachment target 3 such that the shape thereof is maintained by flexural rigidity. Thus, even if a load is applied to the flat electric wire bundle 6 from above, an upward component F1 of a flexural rigidity force F suppresses vibration. Accordingly, it is possible to make the flat electric wire bundle 6 less likely to vibrate.

FIG. 13 shows an example where vibration is imparted to the flat electric wire bundle 6. In the case of this example, the flat electric wire bundle 6 has a deflected shape, and thus flexural rigidity acts on the flat electric wire bundle 6, and deformation is unlikely to occur. Thus, even if vibration is imparted to the flat electric wire bundle 6, the flexural rigidity of the flat electric wire bundle 6 in a deflected shape works to suppress upward and downward (directions in FIG. 13) deformation. Also, a counter force from the clip 9 acts when the flat electric wire bundle 6 vibrates, and thus it is also possible to suppress downward vibration to a low level.

With the clip 9 in the above embodiment, effects such as the following can be obtained.

(1) The clip 9 fixes the flat electric wire bundle 6 in which electric wires 5 are lined up parallel to each other, to the attachment target 3. The clip 9 is provided with the first support portion 12, the second support portions 13, and the retainer portion 14. The first support portion 12 supports the flat electric wire bundle 6 from one side. The second support portions 13 sandwich and support the flat electric wire bundle 6 together with the first support portion 12. The retainer portion 14 retains the flat electric wire bundle 6 sandwiched by the first support portion 12 and the second support portions 13.

With the configuration of this example, inserting the electric wires 5 between the first support portion 12 and the second support portions 13 results in the group of electric wires 5 becoming the flat electric wire bundle 6, and the electric wires 5 are fixed to the attachment target 3 by fixing the clip 9, to which the flat electric wire bundle 6 is attached, to the attachment target 3. Thus, when the flat electric wire bundle 6 is fixed to the attachment target 3 using the clip 9, the closer of the first support portion 12 and the second support portions 13 to the fixing portion 11 enables the flat electric wire bundle 6 to be disposed distanced from the attachment target 3. Accordingly, the flat electric wire bundle 6 is disposed elevated away from the attachment target 3, and thus, even if the flat electric wire bundle 6 vibrates, a situation where the electric wire bundle comes into contact with the attachment target 3 is unlikely to occur. Thus, it is possible to mitigate the occurrence of knocking sounds caused by vibration.

(2) The first support portion 12 is a single columnar member. The second support portions 13 are two columnar members. With this configuration, by performing the simple operation of inserting the electric wires 5 between the three columnar members, the electric wires 5 can be attached to the clip 9.

(3) The end surface 30 of the first support portion 12 that comes into contact with the flat electric wire bundle 6 is disposed further in than the end surfaces 31 of the second support portions 13 that come into contact with the flat electric wire bundle 6. That is, the first support portion 12 and the second support portions 13 are each disposed at positions where the electric wires 5 can be lifted and bent from below. With this configuration, the electric wires 5 passed between the first support portion 12 and the second support portions 13 can be bent and pressed obliquely upward by the two second support portions 13. Accordingly, the electric wires 5 between adjacent clips 9 can have a deflected shape (for example, an arch shape), and thus the electric wires 5 can be farther separated from the attachment target 3. Thus, the effect of mitigating knocking sounds is further increased.

(4) The first columnar support portion 12 has a diameter W1 that is larger than the diameter of the second columnar support portions 13. With this configuration, the first support portion 12 can be made highly rigid.

(5) The clip 9 is provided with the holding portion 10 including the first support portion 12 and the second support portions 13, and the fixing portion 11 that is to be fixed to the attachment target 3. The fixing portion 11 supports the holding portion 10. With this configuration, the holding portion 10 including the first support portion 12 and the second support portions 13 can be firmly supported by the fixing portion 11.

(6) The second support portions 13 are disposed in contact with the fixing portion 11 or in a state where no gap is present between the second support portions 13 and the fixing portion 11. With this configuration, the second support portions 13 can be supported by the fixing portion 11, and thus the rigidity of the second support portions 13 can be increased.

(7) The fixing portion 11 and the holding portion 10 are separate structures. With this configuration, the freedom of the shapes of the holding portion 10 and the fixing portion 11 can be increased. Thus, for example, the shape of the holding portion 10 can be shaped so as to facilitate attachment of the electric wires 5. Accordingly, workability when attaching the electric wires 5 to the attachment target 3 using the clip 9 can be improved.

(8) The clip 9 is provided with the locking mechanism 27 that locks the assembled state of the fixing portion 11 and the holding portion 10 when the fixing portion 10 is assembled to the fixing portion 11. With this configuration, the holding portion 10 assembled to the fixing portion 11 can be made less likely to come loose from the fixing portion 11 by the locking mechanism 27.

(9) The retainer portion 14 is provided with the first retaining portion 15 provided on the holding portion 10, and the second retaining portion 16 provided on the fixing portion 11. When the holding portion 10 is assembled to the fixing portion 11, the second retaining portion 16 is coupled to the leading end 21 of the first support portion 12 and the leading ends 22 of the second support portions 13. With this configuration, for example, even if the entrance for inserting the electric wires 5 is provided in the holding portion 10, when the holding portion 10 is assembled to the fixing portion 11, this entrance can be closed by the second retaining portion 16 of the fixing portion 11. Thus, the ease with which the electric wires 5 can be attached can be increased together with suppressing dislodgment of the electric wires 5.

(10) When the electric wires 5 are made unlikely to come into contact with the attachment target 3, concern regarding external damage and bending is reduced, and thus electric wires 5 without an exterior member can also be used. This leads to keeping the cost of components for the electric wires 5 and the wire harness 2 low.

(11) The wire harness 2 is highly resistant to vibration, which leads to a reduction in the number of clips 9. Also, if the number of clips 9 can be kept low, less work is required to attach the clips 9, which further contributes to simplification of the attachment operation.

(12) The deflected shape is a circular arc-like arch shape. With this configuration, a well-balanced deflected shape can be obtained, and thus vibrations imparted to the electric wires 5 can be efficiently suppressed.

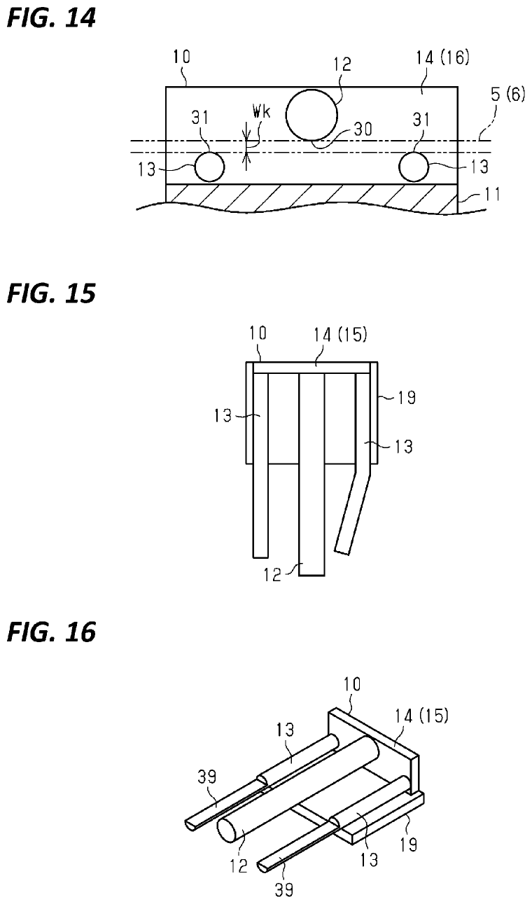

Note that the present embodiment can be implemented with modifications such as the following. The present embodiment and the following modified examples can be combined and implemented, provided that no technical contradiction arises.
As shown in FIG. 14, an interval Wk in the height direction between the end surface 30 of the first support portion 12 that comes into contact with the flat electric wire bundle 6 and the end surfaces 31 of the second support portions 13 that come into contact with the flat electric wire bundle 6 may be set to match the diameter of the electric wires.

With this configuration, when the electric wires 5 are attached to the clip 9, only the support portions (the first support portion 12 and the second support portions 13) of the clip 9 can be brought into contact with the electric wires 5. Thus, contact portions between the electric wires 5 and other members can be suppressed to a low level, and thus the electric wires 5 can be made less likely to rub against another member. Thus, the effect of mitigating knocking sounds can be further increased.
As shown in FIG. 15, a second support portion 13 may have a shape where it is bent at an intermediate portion thereof. In this case, predetermined electric wires 5 of the bundle of the electric wires 5 can be oriented in an arbitrary direction. The routing of the electric wires 5 is thus facilitated, which contributes to making the attachment operation easier to perform. Note that the first support portion 12 may have a shape where it is bent at an intermediate portion thereof, and the first support portion 12 and a second support portion 13 may both have a shape where they are bent at intermediate portions thereof.
As shown in FIG. 16, the second support portions 13 may each be provided with a trimmed portion 39. In this case, various types of electric wires 5 with varying diameters can be attached to the clip 9. Note that the trimmed portion 39 may be provided on the first support portion 12, or provided on the first support portion 12 and the second support portions 13.
The first support portion 12 and the second support portions 13 may have the same diameter W.
The first support portion 12 and the second support portions 13 are not limited to having circular columnar shapes, and may have a polygonal column shape such as that of a triangular prism and a quadrangular prism.
When a plurality second support portions 13 is provided, they are not limited to all having the same shape, and at least one may have a different shape.
There is no limitation on only providing one first support portion 12, and more than one may be provided. Also, there is no limitation to providing two second support portions 13 and one or three or more may be provided.
The first support portion 12 is not limited to being a columnar member, and may be a plate-shaped member, for example. The second support portions 13 are similarly not limited to being columnar members, and may be plate-shaped members, for example.
It is sufficient that the fixing portion 11 be shaped so as to support at least one (a portion) of the constituent elements of the holding portion 10.
The holding portion 10 may be assembled to, for example, a side surface of the fixing portion 11, instead of the upper surface of the fixing portion 11.
A gap of a predetermined size may exist between the fixing portion 11 and the second support portions 13.
The clip 9 is not limited to having a divided structure, and may have a non-divided structure in which the fixing portion 11 and the holding portion 10 are integrated.
The flat electric wire bundle 6 is not limited to being a bundle in which the electric wires 5 are lined up in a single row, and may be formed by stacking, in a height direction, a plurality of electric wire bundles in which electric wires are lined up.
The first retaining portion 15 and the second retaining portion 16 may both be provided on the holding portion 10, for example. In this case, for example, a configuration may be employed where, after the electric wires 5 have been attached to the holding portion 10, the electric wires 5 are retained, and the holding portion 10 is assembled to the fixing portion 11.
Various types of locking mechanisms can be applied as the locking mechanism 27, provided that the locking mechanism is one where the holding portion 10 can be fixed to the fixing portion 11.
All of the electric wires 5 are not limited to being fixed by the clips 9 of this example. For example, the clip 9 of this example may be used for only some of the electric wires 5 while a typical clip (clamp) with another shape or structure is used elsewhere.
The attachment target 3 is not limited to being a vehicle door or the like, and need only be a member constituting the vehicle body.
It is preferable that the attachment target 3 is a copper plate or the like.
The electric wires 5 may be covered by an exterior member.
The method for attaching the electric wires 5 of this example is not limited to being used for a vehicle, and can be applied to various devices and apparatuses.
The present disclosure has been described above based on an example, but the present disclosure is to be construed as not being limited to the example and structures. The present disclosure also encompasses various variations and variations within a range of equivalency. Additionally, various combinations and modes, as well as other combinations and modes including only one element or more or less also fall within the category and range of ideas of the present disclosure.

The present disclosure encompasses the following modes. Reference signs are given to several constituent elements of the exemplary embodiments not for limitation but to aid in comprehension. Some of the items described in the following modes may be omitted, and several items of the modes may be selected or extracted and combined.

[Supplementary Note 1]

A clip (9) according to several modes of the present disclosure includes:
a holding portion (10) configured to hold a plurality of electric wires (5) that are lined up in parallel to each other; and
a fixing portion (11) configured to be attached to the holding portion (10).

[Supplementary Note 2]

In several implementation examples, the holding portion (10) may have:
a circular columnar first support portion (12);
second support members (13), which are two circular columnar members, that sandwich the plurality of electric wires (5) lined up in parallel together with the first support member (12); and
a first retaining portion (15) to which a base end of the first support portion (12) and base ends of the second support portions (13) are coupled.

[Supplementary Note 3]

In several implementation examples, the fixing portion (11) may have a second retaining portion (16) that engages with a leading end of the first support portion (12) and leading ends of the second support portions (13).

[Supplementary Note 4]

In several implementation examples, at least one of the first retaining portion (15) and the second retaining portion (16) may have a plate shape.

[Supplementary Note 5]

In several implementation examples, the holding portion (10) may have a plate-shaped insertion portion (19) protruding from the first retaining portion (15), and the fixing portion (11) may have a groove portion (20) into which the insertion portion (19) is to be inserted.

[Supplementary Note 6]

In several implementation examples, the groove portion (20) may have an opening in one end surface of the plate-shaped fixing portion (11).

[Supplementary Note 7]

In several implementation examples, in the extension direction of the electric wires (5), the first support portion (12) may be disposed between the two circular columnar members forming the second support portions (13).

[Supplementary Note 8]

In several implementation examples, the two circular columnar members forming the second support portions (13) and the first support portion (12) may be arranged such that the electric wires (5) sandwiched therebetween are deflected.

[Supplementary Note 9]

In several implementation examples, the first support portion (12) and the two circular columnar members forming the second support portions (13) may be arranged parallel to each other.

[Supplementary Note 10]

In several implementation examples, the diameter of each of the two circular columnar members forming the second support portions (13) may be larger than the distance between the first support portion (13) and the fixing portion (11).

### LIST OF REFERENCE NUMERALS

1 Electrical component
2 Wire harness
3 Attachment target
4 Body
5 Electric wire
6 Flat electric wire bundle
9 Clip
10 Holding portion
11 Fixing portion
12 First support portion
13 Second support portion
14 Retaining portion
15 First retaining portion
16 Second retaining portion
19 Insertion portion
20 Groove portion
21 Leading end
22 Leading end
23 Recessed portion
24 Recessed portion
27 Locking mechanism
28 Plate spring
29 Recessed portion
30 End surface
31 End surface
34 Main body portion
35 Flange portion
36 Protruding piece
38 Hole
39 Trimmed portion
   W Diameter
   W1 Diameter
   F Rigidity force
   F1 Upward component
   Wk Interval

1. A clip for fixing a flat electric wire bundle in which a plurality of electric wires are lined up parallel to each other to an attachment target, the clip comprising:
a first support portion configured to support the flat electric wire bundle from one side;
a second support portion configured to sandwich and support the flat electric wire bundle together with the first support portion; and
a retainer portion configured to retain the flat electric wire bundle sandwiched between the first support portion and the second support portion.

2. The clip according to claim 1,
wherein the first support portion is a single columnar member, and
the second support portion is two columnar members.

3. The clip according to claim 2,
wherein an end surface of the first support portion that comes into contact with the flat electric wire bundle is disposed further in than end surfaces of the second support portions that come into contact with the flat electric wire bundle.

4. The clip according to claim 1,
wherein the columnar first support portion has a larger diameter than the columnar second support portions.

5. The clip according to claim 1,
wherein an interval in a height direction between an end surface of the first support portion that comes into contact with the flat electric wire bundle and end surfaces of the second support portions that come into contact with the flat electric wire bundle is set to match the diameter of the electric wires.

6. The clip according to claim 1, further comprising:
a holding portion including the first support portion and the second support portions; and
a fixing portion configured to support the holding portion and to be fixed to the attachment target.

7. The clip according to claim 6,
wherein the second support portions are disposed in contact with the fixing portion or in a state where no gap is present between the second support portions and the fixing portion.

8. The clip according to claim 6,
wherein the fixing portion and the holding portion are separate structures.

9. The clip according to claim 8, further comprising:
a locking mechanism configured to, when the holding portion is assembled to the fixing portion, lock an assembled state of the fixing portion and the holding portion.

10. The clip according to claim 6,
wherein the retainer portion includes a first retaining portion provided on the holding portion, and a second retaining portion provided on the fixing portion, and
when the holding portion is assembled to the fixing portion, the second retaining portion is coupled to a leading end of the first support portion and leading ends of the second support portion.

11. A wire harness comprising:
a clip configured to fix a flat electric wire bundle in which a plurality of electric wires are lined up parallel to each other to an attachment target,
wherein the clip includes:
a first support portion configured to support the flat electric wire bundle from one side;
a second support portion configured to sandwich and support the flat electric wire bundle together with the first support portion; and
a retainer portion configured to retain the flat electric wire bundle sandwiched between the first support portion and the second support portion.
